(19) United States
(12) Patent Application Publication
(10) Pub. No.: US 2023/0077007 A1
(43) Pub. Date: Mar. 9, 2023

(54) MULTI-MATERIAL ELECTRODE DEVICES AND METHODS THEREOF

(71) Applicant: Capacitor Foundry LLC, Sand City, CA (US)

(72) Inventors: Jonathan PHILLIPS, Pacific Grove, CA (US); Francisco Javier Quintero CORTES, Monterey, CA (US)

(73) Assignee: Capacitor Foundry LLC, Sand City, CA (US)

(21) Appl. No.: 17/895,829

(22) Filed: Aug. 25, 2022

Related U.S. Application Data
(60) Provisional application No. 63/237,272, filed on Aug. 26, 2021.

(51) Int. Cl. H01G 4/20; H01G 4/008

(52) U.S. Cl. CPC H01G 4/20; H01G 4/008

(57) ABSTRACT

A multi-material electrode device is disclosed. The multi-material electrode device includes a first electrode, a dielectric material coupled to the first electrode, and a second electrode coupled to the dielectric material. In the multi-material electrode device, the first electrode and the second electrode do not include the same material.

### CROSS REFERENCE TO RELATED APPLICATIONS

This application claims the benefit of U.S. Provisional Patent Application No. 63/237,272, filed on Aug. 26, 2021, which is hereby incorporated by reference in its entirety.

### TECHNICAL FIELD

The present teachings relate generally multi-material electrode devices and, more particularly, to apparatus and methods for energy storage related to multi-material electrode devices.

### BACKGROUND

Multi-material electrode devices (MMEDs or MEDS) can be fabricated with a variety of designs, but in general, they all have elements of a typical parallel plate capacitor, for example, electrodes, electrically insulated from each other, separated by or surrounded by dielectric material. MMEDs may be of interest in a variety of technology areas, but energy storage is of particular interest. Alternate technologies having utility in energy storage, such as supercapacitors, are typically constructed with high-surface area carbon electrodes, have maximum voltages on the order of 2.7 V, energy densities of 5-10 Wh/kg, and costs of approximately 2400-3000 $/kWh. Lithium-ion batteries are typical fabricated using graphite and lithium metal oxide electrodes, have maximum voltages on the order of 3.5 V, energy densities of 240-300 Wh/kg, and costs of approximately 160 $/kWh.

Novel paradigm supercapacitors (NPS) are known in the art, but have associated challenges, including increasing operating voltages, long-term stability, and minimization of leakage current while meeting cost targets on the order of lithium-ion batteries, or 160 $/kWh. MMED technology has potential to use a variety of electrode and dielectric compositions, and improve metrics such as operating voltages, energy density, and cost. Challenges remain in energy storage applications utilizing MMEDs including meeting or exceeding requirements related to sustained number of cycles by MMEDs, leakage currents, voltage limits, efficiency, as well as understanding the mechanisms of charge storage related to MMEDs.

Thus, devices and associated methods related to multi-material electrode devices that meet or exceed the aforementioned criteria are needed.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A multi-material electrode device is disclosed. The multi - material electrode device includes a first electrode. The multi-material electrode device also includes a dielectric material coupled to the first electrode. The multi-material electrode device also includes a second electrode coupled to the dielectric material. In the multi-material electrode device, the first electrode and the second electrode do not include the same material.

Implementations may include a multi-material electrode device where the first electrode may include a carbon-based material and the second electrode may include a metal. The second electrode may include aluminum, copper, titanium, or a combination thereof. The first electrode may include a first metal and the second electrode may include a second metal. The first electrode may include aluminum. The first electrode may include aluminum, copper, titanium, or a combination thereof. The second electrode may include a carbon-based material. The dielectric material of the multi-material electrode device may include a gel-like material. The dielectric material may include a fumed silica and a salt solution. The dielectric material is a gel like material may include of fumed silica, water, and a salt. The dielectric material may include a fumed silica, an organic liquid and a salt. The organic liquid may include ethylene glycol. The dielectric material of the multi-material electrode device may include a solid oxide powder, a liquid, and a dissolved salt. The dissolved salt may include a salt of an alkali metal. The dissolved salt may include a salt of an alkali earth metal. The dissolved salt may include a cationic salt. The dissolved salt may include a zwitterionic salt. The liquid of the dielectric material may include water. The dielectric material may include a solid material saturated with a salt solution. The solid material in the dielectric material may include a polymer. The solid material of the dielectric material may include a fibrous solid. The salt solution of the dielectric material may include ethylene glycol and a salt of an alkali metal. The salt solution may include ethylene glycol and a salt of an alkali earth metal. The salt solution may include water and a salt of an alkali metal. The salt solution may include water and a salt of an alkali earth metal. The salt solution may include a cationic salt or a zwitterionic salt. The dielectric material may include potassium iodide. The dielectric material may include an absorbent fiber material. The multi-material electrode device may include an insulating layer separating the first electrode from the second electrode, and the dielectric material may cover the surfaces of the electrodes not in contact with the insulating layer. The insulating layer of the multi-material electrode device may include polyethylene. The dielectric material may form an external layer enclosing the first electrode and the second electrode.

A multi-material electrode array of multiple multi-material electrode devices is disclosed. The multi-material electrode array may include a first electrode, a first dielectric material coupled to the first electrode, a second electrode coupled to the first dielectric material, and a second multi-material electrode, may include a third electrode a second dielectric material coupled to the first electrode, and a fourth electrode coupled to the first dielectric material. The multi-material electrode device array may include a first electrode and a second electrode that do not include the same material. The multi-material electrode device array may also include where the third electrode and the fourth electrode do not include the same material.

Implementations may include a multi-material electrode device array where the first electrode and the third electrode include a carbon-based material. The first electrode and the third electrode may include titanium. The first electrode and the third electrode may include copper. The second electrode and the fourth electrode may include aluminum. The second electrode and the fourth electrode may include a carbon-based material.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A and 1B are a series of schematics illustrating an RC time constant test circuit, utilizing a galvanastat in an ‘equivalent’ fashion, or as a constant load device during discharge, and a constant voltage device during charging, according to an embodiment.

FIG. 2 is a schematic of cross sections of two electrode MEDs, according to one or more embodiments.

FIGS. 3A and 3B are schematics of four electrode MEDs in an X-Cross Configuration, according to an embodiment.

FIG. 4 is a plot illustrating an MMED G Al discharge after 7.5 V charge for one hour, according to an embodiment.

FIG. 5 is a plot illustrating an MMED G Al discharge after 5 V charge for three hours, according to an embodiment.

FIG. 6 is a plot illustrating discharge of a four electrode MMED G Al from ˜2 Volts to ˜0.65 volts, exhibiting a first voltage pateau) through a 24 KOhm load taking approximately 15 hours, and then sustained at the first voltage plateau (˜0.6 V) for nearly ten days, according to an embodiment.

FIG. 7 is a series of plots illustrating a discharge from a 4-Electrode MMED Al G Charged for 2 hours at 5 V, and subsequently discharged through a 2.4 kOhm (reduced) load, according to an embodiment.

FIG. 8 is a plot illustrating MED G Al Charged to 60 mAh and discharged RC Time constant/24 kOhm load, according to an embodiment.

FIG. 9 is a depiction of Four MED G Al in Series, according to an embodiment.

FIG. 10 is a plot illustrating an ‘initial’ discharge through 5 kOhm load from a parallel bank of four MEDs, charged to 360 mAh, and as shown in FIG. 9, according to an embodiment.

FIG. 11 is a schematic of a standard model of fermi levels in thermoelectric junctions, according to an embodiment.

FIG. 12 is a schematic illustrating electron addition during MED charging, according to an embodiment.

FIG. 13 is a schematic illustrating dipole field cancellation and exhibiting the dipoles created by uncompensated charges in the electrodes cancelled by the superdielectric material between the conductors of an MMED, according to an embodiment.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

Lower cost energy storage devices offering improvements over known technology, such as novel paradigm supercapacitors (NPS) and Li-ion batteries are desirable. Embodiments as described herein include multi-material electrode devices (MMEDs) having more than one electrode where the electrodes are not built or fabricated from the same material. Examples of the electrode materials used in two-electrode, high energy dense MMEDs include MMEDs in which one electrode is fabricated from a carbon-based material, such as graphite, and the other electrode is fabricated from a metal, for example, aluminum. MMEDs as described herein further include configurations wherein one electrode is titanium and the other is aluminum, or one electrode is copper and the other electrode is carbon-based, i.e., graphite. Another exemplary embodiment of MMEDs includes the selection of a suitable dielectric material, in particular, the use of superdielectric materials (SDM), such as ethylene glycol (EG) with dissolved potassium iodide (KI) deionized (DI) water with dissolved KI. Embodiments also include MMED structures having a variety of electrode-dielectric geometries or arrangements, and the organization of multiple MMEDs, also referred to as MMED arrays, to create even higher power output than observed with single MMEDs

Multi-material electrode devices of structures and compositions as described in detail below, exhibit an unprecedented pattern of electrical energy storage. Testing of embodiments described herein show the MMEDs have properties that are significantly advantaged as compared to supercapacitors in terms of energy density and are clearly superior to supercapacitors in terms of energy quality. This would suggest that MMEDs, may successfully compete as a commercial source of electrical energy storage technology. Exemplary embodiments of MMEDs, for example, those utilizing low-surface area carbon and aluminum electrodes have been demonstrated to have an operating max voltage of 1.8 V, an energy density on the order of approximately 13 Wh/kg, and a cost range of 100-200 $/kWh, which is comparable to or exceeds that of novel paradigm supercapacitors (NPS) and Li-ion batteries.

Business cases related to energy storage is based on $ of material/unit of energy stored. The forecasted results show that projected retail MMED materials costs significantly outperforms even the best-known commercial supercapacitors and competes with current contemporary battery costs. The expectation is that with further development, MMED costs per unit of energy will decrease further, and improve in performance on the order of over 50% performance increase in the short term. For example, capacitive storage costs of MMEDs have been demonstrated at less than 1% cost in terms of $/Farad as compared to known capacitive storage solutions. In terms of battery storage, as quantified by $/kWhr, MMEDs have been demonstrated at less than 60% as compared to li-ion based battery storage, at commercial maturity.

While exemplary embodiments of MMEDs may be structured according to several designs, the basic architecture of all MMEDs is similar to typical parallel plate capacitor. The MMEDs have more than one electrode, separated by, or surrounded by, a dielectric material. Several important requirements or features include the identity of the materials in the electrodes and in the dielectric material. With respect to the electrodes, as described herein, the MMED must have electrodes of distinctly different conductive materials. Examples of high energy dense MEDS described later include two electrode devices in one electrode is carbon-based, i.e., graphite, and the other electrode is a metal, such as aluminum, one electrode is a metal, such as titanium and the other is a metal such as aluminum, one electrode is metal, such as copper and the other electrode is carbon-based, for example, graphite. Additional carbon-based materials may include, in addition to graphite, other forms of carbon or composites including carbon including, but not limited to, spherical carbon powder, graphene, carbon nanotubes, carbon nanosheets, or graphite intercalation compounds, or combinations thereof. Graphite intercalation compounds, also referred to as GICs are materials having a formula CXm where an ion Xn+ or Xn− is inserted or intercalated between one or more oppositely charged carbon layers. In most cases, m is much less than 1. GIC materials can be deeply colored solids that exhibit a range of electrical and redox properties of potential applications. It is thought that these graphite intercalation compounds may have different Fermi levels than simple graphite, as well as a different density of states in the conduction band. In general, Xn+ or Xn− can be an alkali metal or alkali earth metal. Certain embodiments of MMEDs may have a first electrode made of copper, zinc, aluminum, silver, gold, platinum, or other metals or transition metals, or combinations thereof. Furthermore, Certain embodiments of MMEDs may have a second electrode made of copper, zinc, aluminum, silver, gold, platinum, or other metals or transition metals, or combinations thereof. There may also material pairings that do not produce MMEDs, including MMEDs in which one electrode is titanium and the other is graphite based. A second material requirement of high energy dense MMEDs, as disclosed herein, is the use of superdielectric materials (SDM). For example, in devices described below, the dielectric employed is a ‘superdielectric’ composed of ethylene glycol (EG) with dissolved potassium iodide (KI), or DI water with dissolved KI. Additional superdielectrics composed of nitrates, chlorides or basic solutions dissolved in water, may also be used as superdielectric materials. Certain embodiments of superdielectrics incorporating organic solvents containing dissolved salts, as well as mixtures of salts, water and organics, may be used. MMEDs may also incorporate superdielectric material such as salt, acid, base, or mixtures thereof. Salts may include nitrates, nitrides, carbides, alkali halides, metal halides, mixtures thereof, or other materials that may dissolve in water or organic solvents to create dissolved ions.

A third feature of MMEDs, as described herein, is the arrangement, or geometrical architecture, of the dielectric material within the overall structure of the MMED. For example, in a two-electrode device there are two MMED arrangements. In the traditional variant of the two-electrode MMED, the dielectric is placed in position between the electrodes. This is a similar architecture employed in traditional electrostatic capacitors. For example, one of the devices described consists of a graphite-based electrode and an aluminum electrode made from aluminum foil, which are separated by an absorbent fiber material, paper towel, saturated with a solution of ethylene glycol/potassium iodide (EG/KI). In another embodiment, referred to as an outer dielectric architecture, the same dielectric material, absorbent fiber material saturated with a solution of EG/KI is used, but it is placed around the outside of both electrodes, thus enclosing both electrodes. Moreover, the dielectric material on the outside of one electrode (e.g. the top electrode) is in physical contact with the dielectric material on the outside of the other electrode (e.g. bottom electrode) via a non-conductive absorbent bridge (e.g. paper towel/EG/KI). In the outer dielectric device, a thin electrically insulating layer of low-density polyethylene (LDPE) is placed between the two electrodes. The architecture of the outer dielectric configuration, as implied by the name, is different from that of a traditional parallel plate capacitor. Traditional parallel plate capacitors do not have dielectric on the outside of the electrodes. It should be noted that the components of the MMEDs as described herein are inexpensive and readily available, and that arrays of MMEDs may have traditional geometries, outer dielectric geometries, or a combination of both. There may be additional variations of the design of the MMEDs. Certain embodiments may include four electrodes and four dielectric layers. This design and others are described in more detail later.

Additionally, performance characteristics of MMEDs provide significant advantages as compared to known technologies in energy storage. The following steps describe the process and observations made in some preliminary investigations of MMEDs First, the devices were ‘charged’, in a similar manner as charging a capacitor, at a constant voltage, between 5 and 7.5 V for from about 1 hour to about 35 hours. Second, the discharge through a load, generally a 24 KOhm resistor, was initiated. The circuit used for the discharge is fairly simple. The so-called ‘RC Time Constant’ circuit is employed universally to study the exponential decay of the voltage of ordinary capacitors. Generally, in the first stage of the discharge the MMED behaves like a standard capacitor-like discharge in the same RC time constant circuit. Specifically, the voltage starts at about 1.8 V and declines in a linear fashion, over a period of between 15 and 25 hours, to a voltage that reflects the identity of the electrodes and the load. For example, in a graphite/aluminum system, the voltage reaches a consistent level at nearly 0.6 volts for a 24 kOhm load. It is notable that standard capacitors with nearly the same structure as the MMEDs described, the difference being that both capacitor electrodes were composed of the same material, e.g. graphite, discharged at least five times faster. In other words, the capacitor discharge time from 1.8 to 0.6 V was less than 3 hours, as compared to 15 to 24 hours for the MMED. Moreover, there is no ‘pause’ in the voltage of the capacitor of standard design as it continues to decline. By contrast, once the MMED voltage reached a charging-time dependent voltage, approximately 0.6 V after a five-hour charge, the voltage held steady for 40 hours. This time at the steady voltage was found to be a function of charging time. That is, the voltage held steady for at least 500 hours or more after a charge for 35 hours at 5 V. This ‘steady voltage’ behavior is unprecedented, as normal capacitors discharged through a constant load show an exponential decline in voltage down to zero volts. Other variants on normal electrostatic capacitors, particularly those employing superdielectric materials, show deviation from the classic, expected exponential decay, but nonetheless always show a steady decline in voltage during discharge through a constant load.

The final, unprecedented stage of the discharge is referred to as ‘second plateau’ behavior. Once the high voltage time limit is reached, the MMED voltage fairly rapid declines over approximately three hours, and then reaches a second voltage plateau, which appears to have an infinite timeline. The voltage at this second plateau has been established to continue to remain ‘flat’ for more than 600 hours in experimentation. This second plateau voltage is a function of the electrode material composition. For example, the second plateau voltage of an MMED with an aluminum electrode and a graphite electrode is ˜0.2 Volts, whereas, for an aluminum/titanium electrode configuration, the ultimate second plateau voltage is on the order of about 10 mV.

Therefore, the MMEDS exhibit behavior typically associated with both capacitors and batteries but is well described by neither. In fact, the initial discharge of the MMED exhibits behavior similar to a capacitor discharge, and the first plateau behavior exhibits behavior similar to a battery. These and other behaviors are difficult to explain with either model, or other conventional models. For example, the voltage of the first plateau is clearly function of the load. It appears that the output power, clearly load dependent, is nearly constant. However, the voltage does not behave as expected, which is atypical of battery behavior. Second, the voltage of the first plateau is also a function of the charging time. Battery voltage is typically only a function of the free energy change of the chemical reaction driving the process. Finally, the second plateau appears to be based on ‘borrowed charge’ as the end of the first plateau corresponds to a ‘charge balance.’ That is, the galvanastat is able to determine ‘net charge accumulation.’ During charging, the net charge accumulation value increases. During discharge, the net charge accumulation decreases. The end time of the first plateau corresponds to that time in which the ‘charge in’ during charging and the ‘charge out’ during discharge are nearly equal.

The second ‘plateau’ behavior observed leads to some ambiguity as to the source of the charge out during the second plateau discharge is unclear. Without being bound by theory, it is postulated that during this period there is true primary battery like behavior, leading to a irreversible corrosion of one of the electrodes. For longer functional life, it is suspected that MMEDs should not be continually run after a ‘negative current’ is observed. Furthermore, it has been challenging to find or fit a model consistent with all of the preceding observations. As will be described later, a model based on ‘dielectric screening’ of a ‘thermoelectric effect’ is presented.

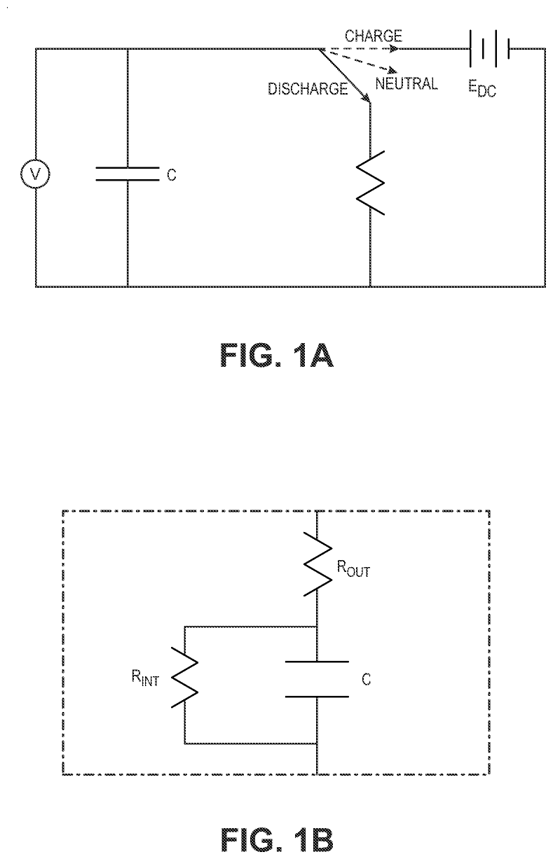

FIGS. 1A and 1B are a series of schematics illustrating an RC time constant test circuit, utilizing a galvanastat in an ‘equivalent’ fashion, or as a constant load device during discharge, and a constant voltage device during charging, according to an embodiment. As shown in FIG. 1, the capacitance for embodiments disclosed herein was measured using a standard RC time constant circuit. Some studies were performed using the galvanastat in the ‘RC time constant mode,’ where during discharge the instrument mimicked a constant resistance load. This approach was employed as it seems to better mimic potential realistic application of the MEDs. The circuit shown in FIG. 1A illustrates a standard circuit. The galvanastat was also used in an ‘equivalent’ fashion, where the galvanastat can act as a constant load device during discharge, and a constant voltage device during charging. The Resistor (R) is selected such that its resistance value is significantly greater than the output resistance of the capacitor (C), as illustrated in FIG. 1B, in order to insure most of the voltage drops across the resistor and is thus measured by the meter (V). The capacitor was always the inner capacitor, as described below, and in this study, it was 24 kOhms, unless otherwise noted.

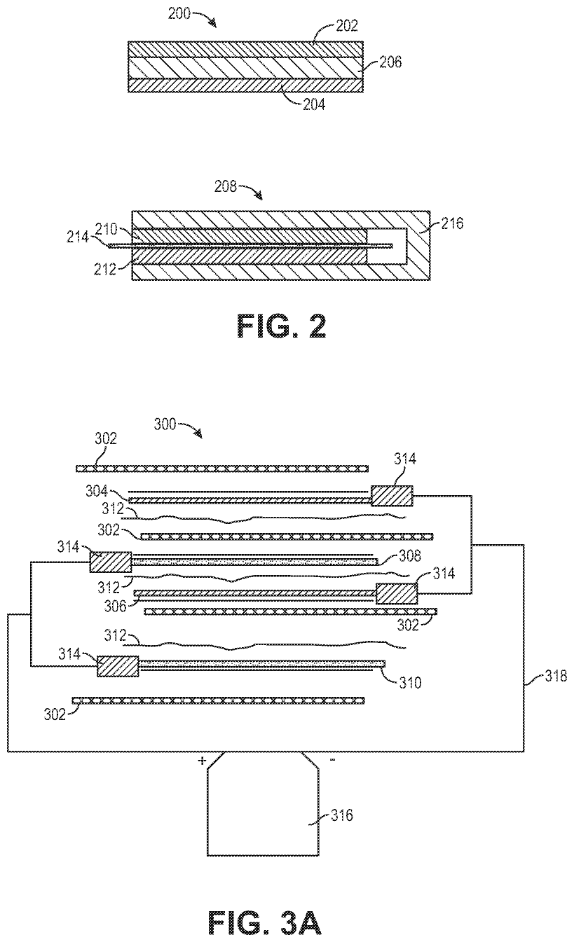

FIG. 2 is a schematic of cross-sections of two-electrode MEDs, according to one or more embodiments. The method of construction results in a significant difference in behavior as compared to conventional parallel plate capacitors. FIG. 2 illustrates a traditional geometry parallel plate capacitor 200, having a first electrode 202, a second electrode 204, and a dielectric layer 206 arranged in between the first electrode 202 and the second electrode 204. Additional connections or accompanying electrical circuits are not shown here for the purposes of clarity. In both the traditional geometry parallel plate capacitor 200 and the outer dielectric geometry capacitor 208, each electrode, except for control studies described herein, was made of a different conductive material. In some embodiments, the MEDs have two electrodes and are similar in construction to standard parallel plate capacitors, as shown in the MED having traditional geometry parallel plate capacitor 200. In the traditional geometry parallel plate capacitor 200, the dielectric layer 206 was fabricated by absorbing a dielectric onto a paper towel and placed between the first electrode 202 and the second electrode 204. The first electrode 202 was made of aluminum and the second electrode 204 was made of a carbon-based conductor. Alternate embodiments may have electrodes fabricated of alternate materials, but the electrodes are never of materials having the same material or conductivity. The outer dielectric geometry capacitor 208 includes a first electrode 210 and a second electrode 212, separated by an insulator later 214 of a thin section of LDPE was placed between the plates. In contrast to the traditional geometry parallel plate capacitor 200, the outer dielectric geometry capacitor 208 has a dielectric layer 216 placed outside of the parallel plates. The first electrode 210 was made of aluminum and the second electrode 212 was made of a carbon-based conductor. Alternate embodiments may have electrodes fabricated of alternate materials, but the electrodes are never of materials having the same material or conductivity.

In the embodiments illustrated in FIG. 2, the electrodes were made in 4 cm-by-4 cm dimensions. The dielectric materials used was either a gel composed of 90 wt % ethylene glycol (EG) with potassium iodide (KI) and 10 wt % fumed silica, or an absorbent fiber material, for example, paper towel, saturated with a liquid composed of KI in ethylene glycol. In the outer dielectric geometry capacitor 208, the dielectric layer 216 included paper towel tabs approximately 2 cm thick, which allowed ion transport between the top and bottom dielectric sections of the dielectric layer 216. While two electrodes are shown in the traditional geometry parallel plate capacitor 200 and outer dielectric geometry capacitor 208, alternate embodiments may have more than two electrodes, such as 4 electrodes, 8 electrodes, or more. In the above illustrated embodiments, the carbon-based electrodes were made from Grafoil sheet. The carbon-based electrodes were created from Grafoil (GTA Grade 0.3 mm thick, from NeoGraf Solutions, Lakewood, OH, USA), a moderate surface area, ˜22 m2/g, graphite material [26, 27] made from compressed graphite flakes., 0.3 mm thick cut into 4 cm by 4 cm squares with one tab (1 cm by 3 cm) on a side for electrical connection. Titanium foil (Sigma Aldrich, Burlington, MA) was wrapped around each Grafoil tab such that the electrical connections could be made using steel alligator clips over the titanium foil and Grafoil. Using this type of connection prevents visible corrosion.

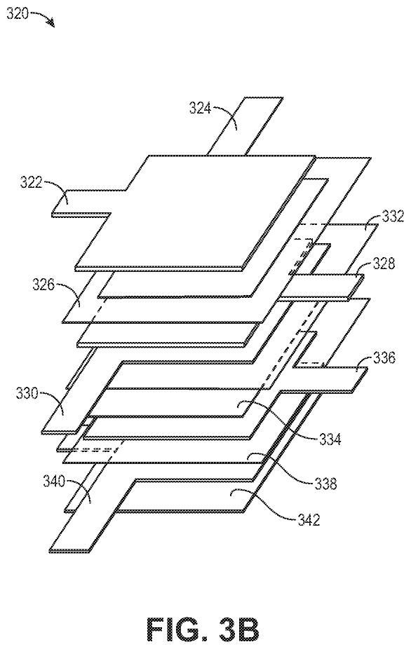

FIGS. 3A and 3B are schematics of four electrode MEDs in an X-Cross Configuration and a variation thereof, respectively, according to an embodiment. FIG. 3A is a cross-sectional side view of a four-electrode MED 300 in an X-cross charging configuration. The four-electrode MED 300 includes several dielectric layers 302 composed of absorbent fiber paper towel soaked with a dielectric fluid or gel, a first electrode 304 made from Grafoil flexible graphite and a second electrode 308 made from aluminum with an additional dielectric layer 302 separating the first electrode 304 and second electrode 308. There is also an insulator layer 312 made from low-density polyethylene separating the first electrode 304 and the dielectric layer 302 between the first electrode 304 and second electrode 308. There is also an insulator layer 312 separating the second electrode 308 from a third electrode 306 made from Grafoil flexible graphite, followed by an adjacent dielectric layer 302. Next, an insulator layer 312 is assembled adjacent to the dielectric layer 302, followed by a fourth electrode 310 followed by a final dielectric layer 302. Each of the four electrodes 304, 306, 308, 310 has a titanium tab 314 as an electrical connector on the end of each electrode 304, 306, 308, 310. The four-electrode MED 300 is powered by a single power supply 316 which is shown connected to each titanium tab 314 connected to each of the four electrodes 304, 306, 308, 310 n a schematic electrical connection 318. In this embodiment, as constructed, the total weight average of several four-electrode systems fully loaded with KI solution was measured to be 2+/−0.1 grams.

FIG. 3B illustrates a perspective, expanded layer view of a second MED, which is also a four-electrode device and a variation on the Capacitor-in-Capacitor in the Criss-cross configuration of FIG. 3A. This four-electrode MMED 320 is also constructed in multiple layers. In order of layers, the four-electrode MMED 320 has the following: a first exterior dielectric layer 322, a first electrode 324 made of a carbon-based material, flexible graphite, a first insulator layer 326 a first interior dielectric layer 328, a second electrode 330 made of aluminum, a second insulator layer 332, a third electrode 334 made of a carbon-based material, flexible graphite, a second interior dielectric layer 336, a third insulator layer 338, a fourth electrode 340 made of aluminum, and a second exterior dielectric 342.

First, each electrode 324, 330, 334, 340 is covered with a layer of gel composed of KI in ethylene glycol (90% by weight) and fumed silica. Next, the absorbent fiber paper towel that provides structure to each of the dielectric layers 322, 328, 336, 342 is then squeezed onto the gel layer. Finally, the absorbent fiber paper towel tabs are loaded with 30 drops each of KI in ethylene glycol solution. Several things should be noted about this configuration shown in FIG. 3B. First, the two aluminum electrodes 330, 340 are connected physically and electrically and connected to one side of the charge/discharge circuit as shown in FIG. 1 and the two Grafoil electrodes 324, 334 are similarly connected and connected to the other polarity of the charge/discharge circuit. Also, the dielectric layers 322, 328, 336, 342 are saturated with a superconducting solution, in this embodiment, KI in ethylene glycol. Finally, the two interior dielectric layers 328, 336 are connected physically, permitting ion travel between the two layers 328, 336, while the other exterior two dielectric layers 322, 342 are similarly physically connected, permitting ion travel.

In alternate embodiments, the first and third electrodes may be carbon-based, titanium, copper, or combinations thereof. Additionally, any other metal or transition metal, as described previously as well as metal alloys can be employed, as well as carbon intercalated with any metal or alkali metal. In certain embodiments, the second and fourth electrodes may be aluminum, carbon-based, or combinations thereof. Additionally, any other metal or transition metal, as described previously as well as metal alloys can be employed, as well as carbon intercalated with any metal or alkali metal. In certain embodiments as described, the dielectric material may be, and the support material may be an absorbent paper, a porous polymer, such as nylon mesh, any polymer material commonly used as a filter material, or a high surface area oxide such as alumina, silica, titania powders or other non-electrically conducting powders or a gel created by mixing any aforementioned electrolyte with a refractory oxide powder. There are several differences between the four-electrode MED 300 in FIG. 3A and the four-electrode MMED 320 in FIG. 3B, as compared to earlier C-in-C capacitors. A C-in-C capacitor refers to any capacitor having more than two electrodes, having all electrodes in a C-in-C made of the same material. The primary difference is the use of two different electrode materials. Also, the use of both a gel and an absorbent media for the dielectric layer, such as a paper towel, permitting liquid dielectric addition to the gel, is employed. Specifically, a gel was made from 10 wt % fumed silica and 90 wt % liquid dielectric. The gel has physical characteristics which allow it to be readily spread onto electrode surfaces.

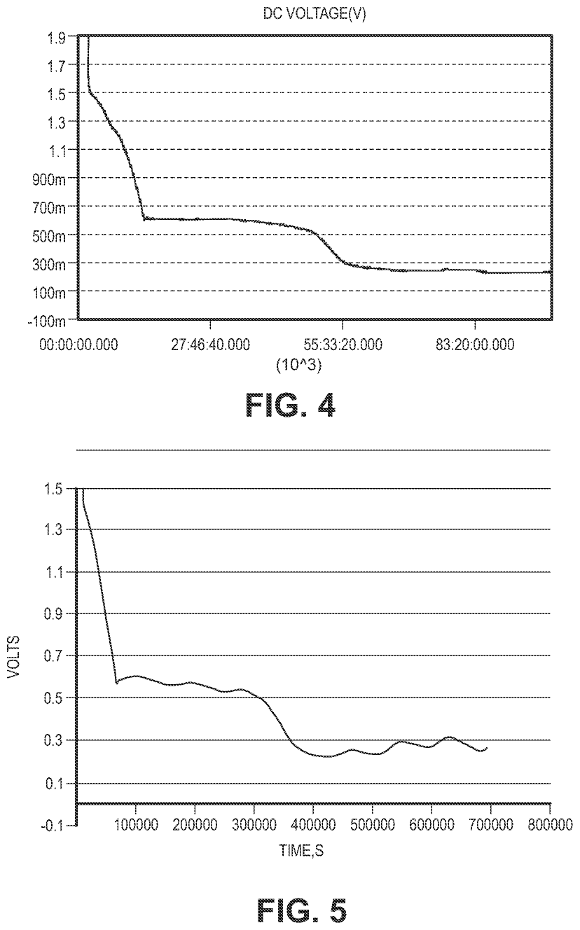

FIG. 4 is a plot illustrating an MMED G Al discharge after 7.5 V charge for one hour, according to an embodiment. The MMED used to generate the data is similar to one as described in regard to FIG. 3B, having both graphite-based and aluminum electrode materials, also referred to as MMED G Al. It should be noted that in the first discharge, the MMED exhibits the three regions of discharge as previously described. In the experiments to generate the data in FIG. 4, and other results described herein, the MMED G Al were first charged at a steady voltage (e.g., 7.5 V) for a specified time, and then discharged through a 24 KOhm load, unless otherwise noted. In the first stage of discharge, the MMED G Al discharged in a linear/exponential fashion for over 15 to >125 hours from about 1.8 volts to a steady state/First Voltage Plateau (FVP) voltage. This second discharge feature of the MMED G Al, the FVP, is unprecedented and no known devices exhibit similar behavior. The FVP voltage was found to be a function of charging time, as the longer the charging time, the more charge accumulated on the electrodes, and thus the higher the FVP voltage. The measured energy discharged through the load during the FVP period following a long charge of approximately 24 hours is expected to be, on a weight basis for the device, far higher than that found for any commercially available supercapacitor. The final unexpected stage of all discharges is referred to as a low voltage plateau (LVP). Once the high voltage plateau time limit is reached, the MMED voltage fairly rapid declines, in this case, over a three-hour period, to about 0.2 V. Subsequently, the MMED appears to remain at this voltage indefinitely.

In the capacitive segment of the discharge the voltage declined in a linear fashion, faster than would be expected for an exponential decline, from ˜1.5 volts to the FVP value (˜0.6 V) over about 16 hours. This first stage capacitive performance exceeds other known device performance. The time to 1 volt, a metric employed in known testing related to C-in-C capacitors is reported to be about 10 hours. By comparison, no known 4 electrode C-in-C of the same size as the MMED G Al, except for those showing significant corrosion, has remained above 1 volt for more than one hour. Once the discharge of the MMED G Al high voltage plateau is reached, the voltage remains nearly constant for a prolonged period with some variation noted over a small range, 580 and 620 mV, with a diurnal pattern. While not wishing to be bound by theory, it is suggested that this observed diurnal variation reflects a temperature variation. The highest voltage corresponded in all cases to a higher ambient temperature, generally reached during the day, while a lower voltage corresponds to a lower ambient temperature, generally reached at night. The high voltage plateau shown only lasted for approximately 40 hours.

FIG. 5 is a plot illustrating an MMED G Al discharge after 5 V charge for three hours, according to an embodiment. The same MMED as tested in regard to FIG. 4 was subsequently re-charged at 5 volts for 3 hours. This is a lower voltage than the first charge, but for a longer time period. The result as shown in the plot of FIG. 5 is that the initial discharge (24 kOhm load) and the first voltage plateau lasted longer times than the first charge. This plot shows the MMED took 12 hours to reach 1 volt and 19 hours to reach the second voltage plateau at around 0.58 V. It remained at the first voltage plateau for 66 hours before beginning the decline in voltage toward the second voltage plateau. This demonstrates a capacitive discharge at least 10% slower with the first voltage plateau lasting more than 50% longer than the data illustrated in FIG. 4. The diurnal nature of the voltage is more evident as well, as the second voltage plateau lasted three days, while showing four corresponding ‘troughs’ and three peaks related to variation of the ambient temperature. Furthermore, the capacitive behavior of the 4 electrode MMED G Al, organized as illustrated in FIG. 3A and 3B, appears to be significantly superior to that observed for known two electrode devices. First, the initial capacitive-like discharge from ˜2 to 0.6 volts takes >60,000 seconds. From the standard equation:

$$ln ( \frac{V}{{V}_{0}} ) = - t / RC \qquad Eq ( 1 )$$

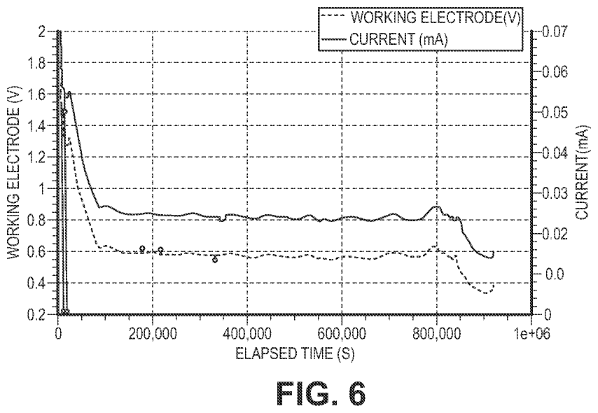

Given the resistance is 24 kOhm, and the discharge time from 1.8 to 0.6 volts is 60,000 seconds the test as shown in FIG. 5 yields a capacitance of approximately 2.3 F for the first stage of the discharge, which is about tenfold better than a similar C-in-C capacitor. The next discharge stage, first voltage plateau, establishes that the four-electrode MED G Al is not only not a capacitor, but also improved as compared to any known two-electrode MMED. Whereas the best two-electrode system discharges for 2.5 days, the four-electrode device, charged in an almost identical fashion, discharges at a nearly constant voltage for ten days. This indicates that further design optimization for such MMEDs is warranted. Additional optimization opportunity may lie with improving the arrangement of the electrodes, arrangement of the dielectrics, material combinations to use in the electrodes, dielectric material, and charging procedure. FIG. 6 is a plot illustrating discharge of a four electrode (MMED G Al) from ˜2 Volts to ˜0.65 volts, exhibiting a first voltage plateau) through a 24 KOhm load taking approximately 15 hours, and then sustained at the first voltage plateau (˜0.6 V) for nearly ten days, according to an embodiment.

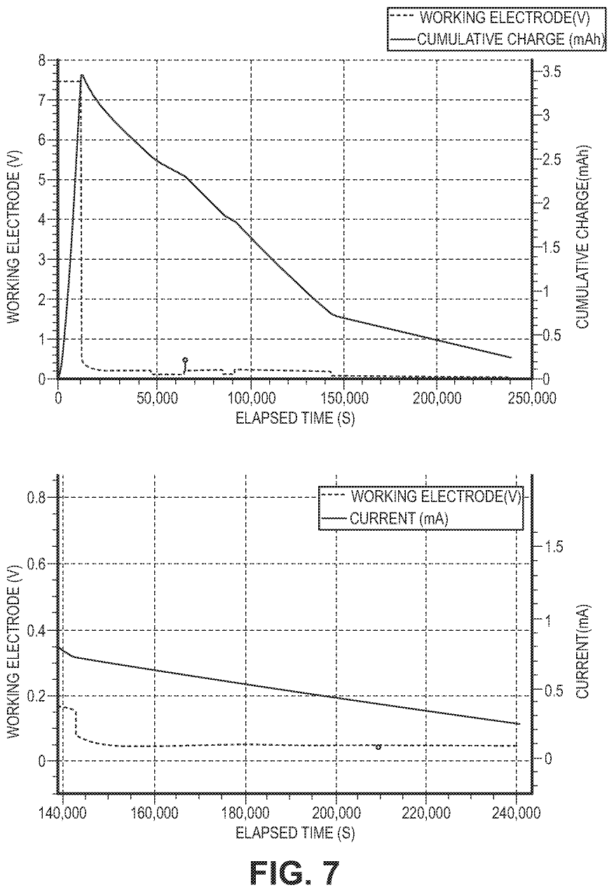

FIG. 7 is a series of plots illustrating a discharge from a 4-Electrode MMED Al G Charged for 2 hours at 5 V, and subsequently discharged through a 2.4 kOhm (reduced) load, according to an embodiment. The data in FIG. 7 exhibits charge conservation, illustrating that charge accumulation into the MMED is nearly linear with charging time. For example, a four-electrode MMED G Al charged to 7.5 V for three hours led to a net accumulated charge of just under 4 mAh. Furthermore, previous data suggested that higher charge accumulations led to longer FVP and possibly higher FVP voltage value. Indeed, the FVP of this discharge through a 2.5 kOhm resistor was less than 0.4 V. Additionally, there appears to be a correlation between the end of the FVP and a reduction of stored charge to ˜1 mAh. These features exhibit a low charge accumulation with low charge time, a lower FVP with lower charge accumulation, and most importantly, an end of FVP predictably occurring at and corresponding with the almost complete discharge of accumulated charge. The blue curve shows net charge on the MMED During charging the accumulation of charge is linear with time, and the discharge is fairly steady (FVP) for approximately 135,000 sec at 0.18 V. The low value of the FVP, relative to that shown in FIGS. 5 and 6, is consistent with the observation that the FVP is a function of the discharge load. The lower portion of FIG. 7 illustrates that after the accumulated charge dropped to about 0.7 mAh the FVP terminated, and the second voltage plateau started at about 0.04 V. It has been noted in other work, not included herein, that even as the accumulated charge trends negative as shown by extrapolating the blue line (cumulative charge, mAh) in the lower plot of FIG. 7, the second plateau continues at about the same voltage.

Three additional observations and conclusions are consistent with the data of FIGS. 6 and 7. First, current leakage, even over 10 days, is virtually zero from the embodiments of MMEDs described herein. All current appears to pass through the load in the data set. Second, the initial discharge voltage never surpasses approximately 2 Volts, no matter the charging voltage. The implication in regard to energy efficiency suggests a low charging voltage be employed. Alternatively, if charging time is most important, an ‘overvoltage’ charging would be preferred. A diagnostic evaluation of MMEDs charged at 5 V or higher indicates that overvoltage charging leads to limited aluminum layer corrosion. Similar corrosion and/or other unwanted or detrimental chemical reactions are known to occur in all battery and supercapcitors. Finally, the constant current accumulation with time as shown in FIG. 7 indicates the system can be charged to a far higher level than previously expected. Unfortunately, as will be described later, this may lead to very long charging times. Regarding the potential impact of charging time, once it was established, as in FIG. 7, that at a given charging voltage the rate of charge accumulation is linear, it may be expected that all the charge must be dissipated through the load it is reasonable to assume the structure of the discharge must be modified in some fashion.

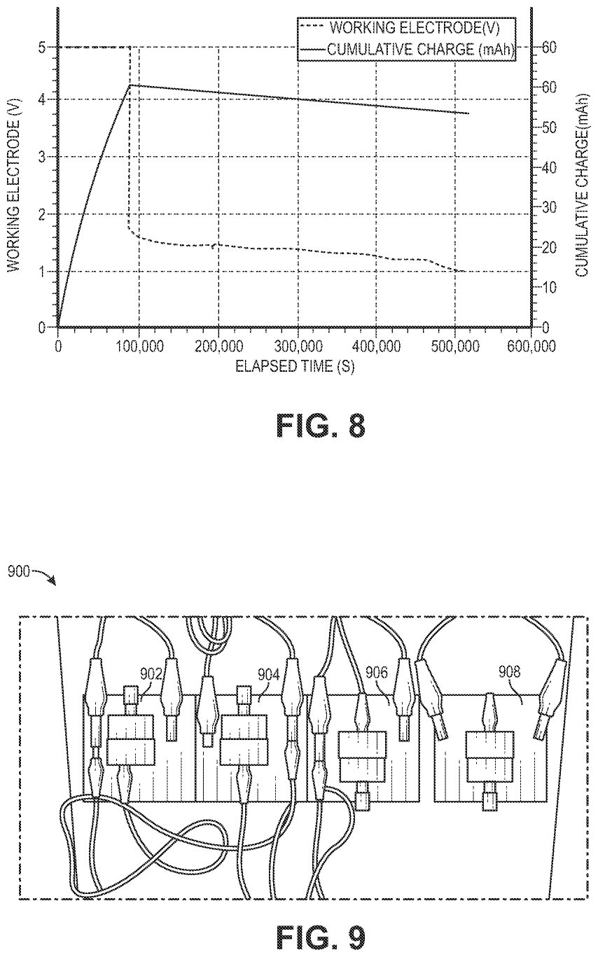

FIG. 8 is a plot illustrating MED G Al Charged to 60 mAh and discharged RC Time constant/24 kOhm load, according to an embodiment. An effort to study the effects of charging time is shown in FIG. 8 for a four-electrode MMED G Al charged at 5 V. The initial charge was to 60 mAh, a charging process that took approximately 24 hours. As the depicted discharge continues, and prior work suggests will continue until charge (blue line) reaches zero. Presently >35 J has passed through the load, and a conservative estimate is that ˜200 J will pass through load before MED drops below 0.5 V. FIG. 8 shows that the cumulative charge accumulation rate (blue line until 85,000 s) is virtually constant for about 10 hours, then decreases. It is also evident that the system is not near a limit. Charge accumulation stopped only because the charging source was switched off. Further charge accumulation is clearly possible, and potentially at a significant amount. Given that the ultimate charge accumulated was 60 mAh, or about 8 times more than in prior studies, this seems to indicate the impact of charge accumulation on the discharge profile. Several trends should be noted. First, the initial discharge voltage is only modestly increased, if at all when comparing FIG. 6 and FIG. 8. Second, the capacitor discharge time is increased eightfold relative to that observed in FIG. 6. Thus, it may be postulated that the capacitive discharge time is a linear function of the amount of charge accumulated. Moreover, the amount of energy released through the load in the capacitive discharge is approximately 35 J. As the amount of energy released in the capacitive discharge section of FIG. 6 is less than 2.5 J, this would indicate the energy release increase is greater than linear with the amount of accumulated charge. Third, it appears that the current discharge rate is very linear. Finally, it appears that the FVP is at almost exactly one volt, much higher than that observed for a smaller charge accumulation.

FIG. 9 is a depiction of Four MMED G Al in Series, according to an embodiment. A multi-material electrode array 900 is shown in FIG. 9, having a first MMED 902 a second MMED 904, a third MMED 906, and a fourth MMED 908, wired in series. The specific power, connections, and wiring is not explicitly shown for the purpose of clarity. Each MMED 902, 904, 906, 908 includes a first multi-material electrode device, having a first electrode, with a first dielectric material coupled to the first electrode, a second electrode coupled to the first dielectric material. A second multi-material electrode, having a third electrode, a second dielectric material coupled to the first electrode, a fourth electrode coupled to the first dielectric material, and where the first electrode and the second electrode are not made from the same material. Also, the third electrode and the fourth electrode are not made from the same material. Each MMED 902, 904, 906, 908, built as shown in FIG. 3, contains four electrodes and four dielectric layers saturated with KI in ethylene glycol, in absorbent paper towel having approximate dimensions of 4 cm by 4 cm, arranged in an outer dielectric arrangement.

The behavior of arrays, also referred to as banks, of MMED devices are also of interest in terms of their design or use in any electrical system, including electrical energy storage systems. Data collected with respect to these arrays of MMEDs suggest that arrays of MMEDs also have interesting behavior. It is expected that each MMED in an array provides a unit of power once the first voltage plateau is reached. It is proposed for MMEDs, without wishing to be bound by theory or this model, in a series circuit, as shown in FIG. 9, discharging through a constant resistance that the following equation may be related to the first voltage plateau by Eq. 2:

Pₜₒₜ=ΣᵢPᵢ (Eq. 2)

According to Eq. 2, the power observed to pass through the load is the sum of the power produced by each MMED in series. This relationship is not observed for batteries or capacitors. For both capacitors and batteries in series the voltages add, rather than the power. It should be noted that for standard capacitors, the voltage is constantly changing as discharge proceeds. The difference in the behavior of a bank or array of MMEDs relative to either batteries or capacitors may be best understood by considering the voltage predicted for the first voltage plateau over an array of identical MEDS discharging through a resistor, R. From Eq. 2 it follows:

$${P}_{t o t} = \frac{{V}_{t o t}^{2}}{R} = {\sum }_{i} {V}_{i}^{2} / R \qquad ( Eq . 3 )$$

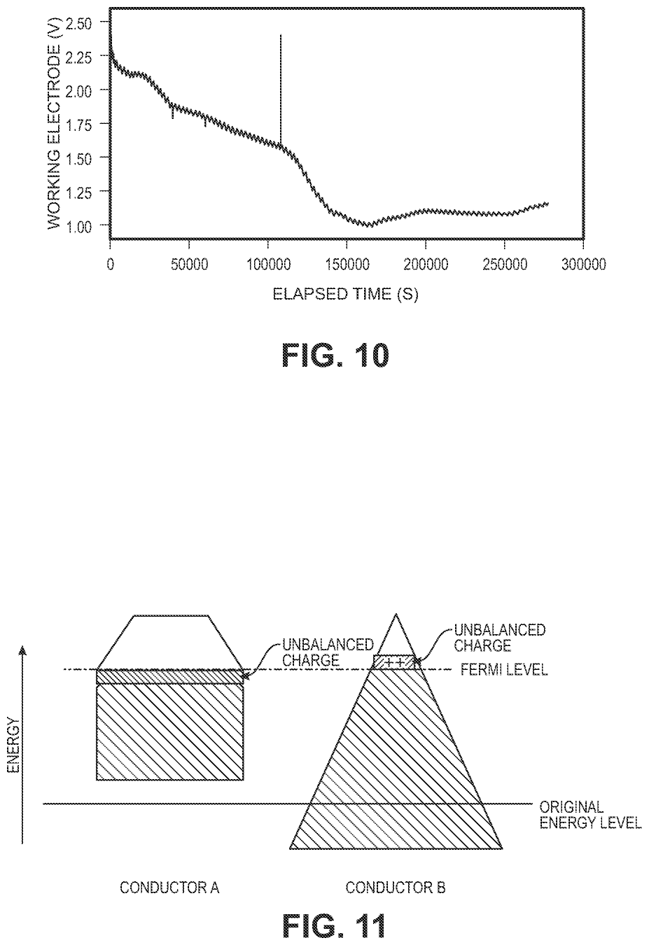

As an illustrative example, and one that corresponds to the described experiment, one may consider a case in which there are four identical MMEDs Thus, Eq. 3 would indicate that the plateau voltage will be twice the plateau voltage of each identical MMED This behavior is clearly distinct from either batteries or capacitors for which the voltage would be predicted to be 4 times any single circuit element. An individual four-electrode MMED G Al first plateau behavior is a function of the load resistor, a result anticipated from Eq. 2. On a qualitative basis, Eq. 3, modified for a single MMED, suggests the lower the resistance the lower the observed voltage drop. This would indicate the relationship of V2/R is constant, hence If R decreases, then V must also decrease. This expectation is in qualitative agreement with all data collected and described herein. The MMED array of FIG. 9, having four identical four-electrode MMED G Al of dimension 4 cm×4 cm was charged, all in a parallel circuit, at 7.5 Volts for approximately two days. The total accumulated charge was 360 mAh. The parallel charging was intended to make certain each MMED saw the same voltage drop. The four MMEDs were then rewired into a series circuit as shown in FIG. 9 in order to have a maximized voltage drop across a single 5 kOhm resistor. A data plot of the voltage over the first 270,000 seconds is illustrative, as shown in FIG. 10.

FIG. 10 is a plot illustrating an initial discharge through 5 kOhm load from a parallel array of four MMEDs, charged to 360 mAh, and as shown in FIG. 9, according to an embodiment.

As is typical with MMEDs as described herein, there are clearly distinct regions of discharge. The initial discharge, also referred to as region I, is ‘capacitor-like,’ as the voltage steadily drops from ˜2.25 volts to approximately 1 volt over a period of about 150,000 seconds. A conservative estimate, based on this data, is that 67 J of energy was dropped over the load during this period. After the capacitor like discharge region I, a near constant voltage region, approx. 0.7 V, was reached. In fact, after 350,000 seconds of discharge the voltage remains in the first voltage plateau (FVP) of >1.1 V, and in this first plateau region, conservatively an additional 48 J is estimated to have passed through the load. Given that only 7% of the accumulated charge to date, 350,000 seconds, has passed through the load, it is further estimated that the total energy that will pass through the load at the termination of the FVP will be greater than 800 J, or 50 J/g. As illustrated in FIG. 10, the first plateau voltage is approximately 1.1 volt. By comparison, a single identical MMED, charged for 3 hours at 5 V, showed an average first plateau voltage of 0.38 V. On the basis of an additive voltage theory that applies to capacitors and batteries, the anticipated voltage for a bank of four would be 1.52 V, and Eq. 2 would suggest a voltage of 0.76 should be observed. However, neither model is quantitatively predictive. The plateau voltage, which is higher than that predicted by Eq. 3 may have resulted from a longer charge period.

Experimental results indicate that MMEDs do not discharge in a fashion consistent with either batteries or capacitors. The initial discharge period shows constant linear, and possibly exponential, voltage decay. This suggests the MMED is displaying capacitive behavior. It should be noted the capacitive behavior is superior to other known devices, as the energy release is on the order of ten times better than capacitors identical in all respects to the MMED except for the fact that both electrodes of the capacitor are of the same material. The next stage of discharge, FVP, is not like any observed alternate capacitor behavior as the voltage is near constant for a prolonged period. In this part of the discharge, the capacitor model fails. The FVP is superficially like a battery in that voltage is constant. However, the battery model fails to explain the lack of observable corrosion, and the dependence of the voltage observed in this phase is not a function of charging time and load value. The existence of a second voltage plateau is neither consistent with any battery or any capacitor model.

In order to better characterize the behavior of MMED, testing of additional key postulates regarding the behavior of MMED are necessary. First, the total amount of charge that is released during the ‘capacitive’ and ‘First Voltage Plateau’ periods of discharge is equal to the charge put into the device during the charging period. This is independent of the load value. Second, for a given charging voltage the amount of charge stored on an MMED is nearly a linear function of the charge time. Third, the total amount of charge which can potentially be stored in an MMED is of the same order of magnitude as an advanced battery of the same volume. Fourth, FVP may be a function of the amount of stored charge. Fifth, charge accumulation may be a function of the charging voltage. Finally, the MMEDs as described herein may have a remarkably low self-discharge rate, or leak rate.

The data as described in regard to FIGS. 4-8 and 10 is consistent with the postulates noted above. If these postulates prove true, it may follow that MMEDs may be designed to store electrical energy at the same density as the most advanced batteries, and they can be recharged faster. A new model may be required to explain the uncharacteristic behavior of MMEDs It is likely that at least three models are required, one for each element of the discharge process. These models for each discharge region are outlined as follows. For the initial voltage decay behavior, it is postulated that during this period the MMED does behave largely like a capacitor, albeit one for which the capacitance, charge/voltage, is remarkably high. For example, the capacitance of the MMED illustrated in FIG. 6 during the discharge from 1.6 volts to 0.6 volts is ˜3.3 F. For the capacitive section of the discharge for the supercharged MMED (FIG. 8), of almost identical volume and mass (˜3.5 g dry) as that illustrated in FIG. 6, the capacitance is ˜19 F. This behavior may simply reflect, as per any capacitor, net charge transfer from one electrode to another during charging and the subsequent ‘re-balance’ of charge by passage through a load between plates.

Regarding the first voltage plateau (FVP), a hitherto-unobserved phenomenon it is a challenge to create a thoroughly validated model this behavior. This is particularly true in electrochemistry where even the behavior of devices known and characterized for centuries, such as batteries, are not well explained by modern physics. What follows is a simple model is offered to explain, partially, the phenomenon of the FVP in terms of the force which acts on the charges on an electrically neutral device, such as a battery, and why electrons move from anode to cathode, dropping energy through a load in the process, when a battery generates no net charge separation and consequently no net electric field. The model may also address the ‘chemical potential gradient’, and how it may act on a charged species. This model is based on the postulate that MMEDs are similar to thermoelectric junctions with one important distinction: a dielectric is present between the two conductors.

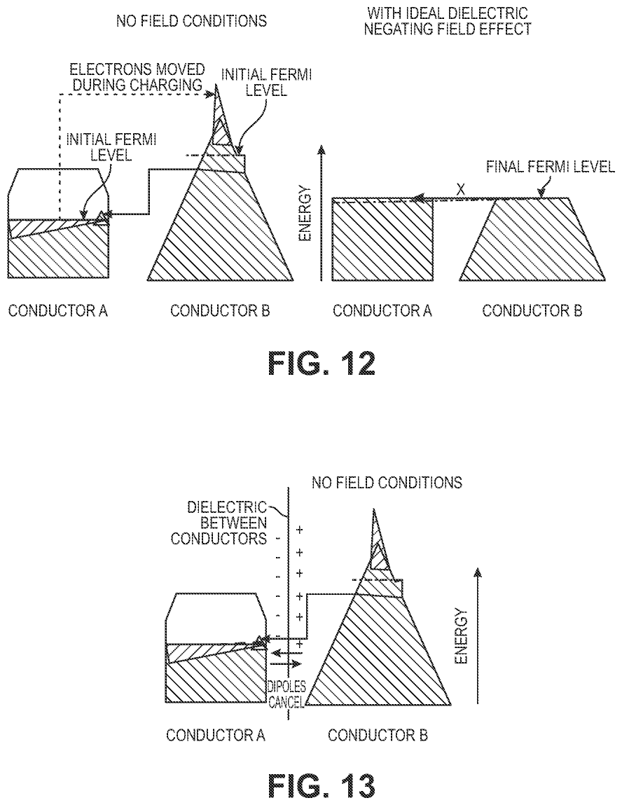

FIG. 11 is a schematic of a standard model of fermi levels in thermoelectric junctions, according to an embodiment. As illustrated, with no dielectric layer between conductor A and conductor B, a charge transfer to the conductor with the lower Fermi energy, leads to uncompensated charge on both sides of the interface, and a concomitant electric dipole. This dipole further reduces the voltage difference across the interface. A first step in explaining the model is to consider a normal thermoelectric junction. As illustrated in FIG. 11, electrons (Fermions) in the conduction band of a material, due to the exclusion principle, cannot occupy the same energy level. This causes the energy of the electrons at the top of the band, the so-called Fermi level, to be well above the ambient temperature in terms of energy. Another aspect illustrated is that the shape and state density of states in the conduction band is different for each conductor. This is a function of the ion core crystal geometry, the number of electrons in the conduction band, as well as other factors. An illustrative example assumes the Fermi level (FIG. 12) of one conductor (A) is 2 eV above ambient, and the other conductor (B) only 0.5 eV above ambient. In order to lower the energy level of the system as a whole, some electrons will ‘spill’ from An into B until the energy level of the electrons at the top of both bands is the same.

It should be noted that the number of charge transfers required to equalize the conduction band energy tops, is influenced by the field generated by charges already transferred. The band receiving electrons incurs a rise in energy from the uncompensated charges, hence field created, by extra electrons. These extra electrons create a field that ‘repulses’ additional electrons, that is, raises the energy of empty band orbitals available for further electron accommodation. In contrast, the net positive charge left behind in the conductor losing electrons will lower the energy of all electrons in its' conduction band. The net positive charge will attract electrons. The impact of the field means the Fermi level energy difference will register as less than the theoretical value. Therefore, two processes serve to bring the two Fermi levels into energy alignment: charge transfer, and the net dipole generated by charge transfer. This model explains the voltage reading found across the junction of two dissimilar conductors.

Also consistent with the model is the well-known fact that the voltage difference across a thermocouple or thermoelectric junction is maximized when there is essentially infinite resistance between the metals. As soon as current is drawn, the measured voltage drops because the two Fermi levels begin to line up. This occurs, as noted above, because of electron spill between conduction bands, which results in a net charge separation. Thus, a net charge separation leads to an electric dipole across the interface. Some current at a reduced voltage, and unfortunately energy, will continue to flow when a low resistance load is placed between the conductors, but this appears to reflect a density of states difference. Both conductors will have some states filled above the Fermi level due to thermal excitation. The number of electrons in these excited states is a function of both temperature and density of states. The highest energy electrons in each conductor will be a complex function of these factors, but it is highly unlikely that the two conductors will have identical highest energy electrons in their conduction bands, and the difference is understood to be accentuated by increasing temperature. Hence, heating leads to continued Fermi level difference and continued spill of electrons from one conductor to the other. A method to increase Fermi level differences, and hence increase power production from thermopiles would be to keep the two metals at distinctly different temperatures. This method is consistent with the standard model of thermoelectrics described.

Given the above standard model of thermoelectrics, a related model is presented regarding how dielectric placement between the two dissimilar conductive electrodes of a thermoelectric couple, a ‘modified’ thermoelectric/MMED, increases the ability to store charge and electric energy relative to the unmodified/standard thermoelectric created using the same two dissimilar electrodes. It may be postulated that MMEDs store remarkable amounts of charge and energy because of enhanced Fermi energy level differences created by the dielectric placed between the electrodes. The charge species in the dielectric between the electrodes is polarized by excess or uncompensated charge on the electrodes created by spillage of electrons from the conductor with the higher Fermi energy to the one with the lower energy. Moreover, as usual for a dielectric in a parallel plate capacitor, it is polarized such that the field created by the polarization is opposite in direction to that created by uncompensated charges on the electrodes. Thus, the dielectric in the MMED, particularly if it is made using a superdielectric material, may be considered to cancel the levelling of energy levels created by charge spillage as happens in the standard thermoelectric. The net impact is that even when charge is allowed to transfer through a load, the original Fermi level voltage difference is maintained in the MMED. In contrast in the standard thermoelectric the voltage difference between electrodes is reduced by charge spillage.

FIG. 12 is a schematic illustrating electron addition during MMED charging, according to an embodiment. As illustrated in FIG. 12, the process of charge transfer of electrons from one electrode to the other during MMED charging is shown. As with capacitors and batteries, it is assumed that the device is net neutral. During charging the process follows Kirchoff s Law: the amount of charge entering a junction equals the amount leaving that junction, and effectively, charge is transferred from one electrode to the other. The actual process involves adding electrons at one electrode and removing them at the other. As shown in FIG. 12 on the left side, electrons added must enter states above the Fermi level and electrons removed must create vacancies below the Fermi level. Also, there are no energy consequences, in contrast to thermoelectrics without dielectrics between conductors, associated with electric fields arising from uncompensated charges. Specifically, the Fermi level of neither electrode in an MMED is modified. As shown on the right side of FIG. 12, is a model indicating that eventually charge transfer between the two sides will stop, and the Fermi levels will become equal after a non-infinite charge transfer. What is not known is how many charges must move or how many excess charges may be added to the conduction band. Theoretically, the conduction band is infinite, and as more electrons are added, the higher the top level of the conduction band, but generally models indicate the density of states increases with increasing voltage. Thus, the number of electrons required to increase voltage increases with increasing addition of electrons. The explanation for the difference between the standard model and the MMED model of the thermoelectric effect is provided in FIG. 12, suggesting that the dielectric material, presumed to be an SDM, is polarized such that it largely cancels the field created by the uncompensated charges on the electrodes. Hence, the voltage difference between electrons in the two electrodes reflects the true Fermi level differences. The impact of the field created by uncompensated charges is therefore minimized.

FIG. 13 is a schematic illustrating dipole field cancellation and exhibiting the dipoles created by uncompensated charges in the electrodes cancelled by superdielectric material between the conductors of an MMED, according to an embodiment. MMED behavior may be related to Fermi level differences in the two conductive materials. This difference is generally reduced by the dipole field created by charge transfer from one conductor to the other. Hence, an ordinary thermoelectric shows a low voltage difference between electrodes once charge transfer is enabled. In contrast, the addition of a dielectric between electrodes in an MMED prevents the field created by uncompensated charge on the electrodes from significantly reducing the difference in voltage related to Fermi level differences. The Fermi voltage is thus stabilized. This model illustrated in FIG. 13 is consistent with the experimental facts described herein. Namely, there is no measurable plateau voltage in a capacitor with two identical electrodes, the plateau voltage observed in MMEDs is a function of the identity of the two electrodes, a charged MMED initially declines as anticipated for a capacitor, but the discharge rate is greatly reduced (ca. 1/10), and the voltage of an MMED remains at the first plateau voltage until virtually all the charge added during the charging process is expended.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of”is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A multi-material electrode device, comprising:
a first electrode;
a dielectric material coupled to the first electrode; and
a second electrode coupled to the dielectric material; and
wherein the first electrode and the second electrode do not comprise the same material.

2. The multi-material electrode device of claim 1, wherein the first electrode comprises a carbon-based material and the second electrode comprises a metal.

3. The multi-material electrode device of claim 2, wherein the second electrode comprises aluminum, copper, titanium, or a combination thereof

4. The multi-material electrode device of claim 1, wherein the first electrode comprises a first metal and the second electrode comprises a second metal.

5. The multi-material electrode device of claim 4, wherein the first electrode comprises aluminum.

6. The multi-material electrode device of claim 4, wherein the first electrode comprises aluminum, copper, titanium, or a combination thereof

7. The multi-material electrode device of claim 1, wherein the second electrode comprises a carbon-based material.

8. The multi-material electrode device of claim 1, wherein the dielectric material comprises a gel-like material.

9. The multi-material electrode device of claim 1, wherein the dielectric material comprises a comprises a solid oxide powder, a liquid, and a dissolved salt.

10. The multi-material electrode device of claim 8, wherein the dielectric material comprises a fumed silica and a salt solution.

11. The multi-material electrode device of claim 8, wherein the dielectric material is a gel like material comprised of fumed silica, water, and a salt.

12. The multi-material electrode device of claim 8, wherein the dielectric material comprises a fumed silica, an organic liquid and a salt.

13. The multi-material electrode device of claim 12, wherein the organic liquid comprises ethylene glycol.

14. The multi-material electrode device of claim 9, wherein the dissolved salt comprises a salt of an alkali metal.

15. The multi-material electrode device of claim 9, wherein the dissolved salt comprises a salt of an alkali earth metal.

16. The multi-material electrode device of claim 9, wherein the dissolved salt comprises a cationic salt.

17. The multi-material electrode device of claim 9, wherein the dissolved salt comprises a zwitterionic salt.

18. The multi-material electrode device of claim 9, wherein the liquid comprises water.

19. The multi-material electrode device of claim 1, wherein the dielectric material comprises a solid material saturated with a salt solution.

20. The multi-material electrode device of claim 19, wherein the solid material comprises a polymer.

21. The multi-material electrode device of claim 19, wherein the wherein the solid material comprises a fibrous solid.

22. The multi-material electrode device of claim 19, wherein the salt solution comprises ethylene glycol and a salt of an alkali metal.

23. The multi-material electrode device of claim 19, wherein the salt solution comprises ethylene glycol and a salt of an alkali earth metal.

24. The multi-material electrode device of claim 19, wherein the salt solution comprises water and a salt of an alkali metal.

25. The multi-material electrode device of claim 19, wherein the salt solution comprises water and a salt of an alkali earth metal.

26. The multi-material electrode device of claim 19, wherein the salt solution comprises a cationic salt.

27. The multi-material electrode device of claim 19, wherein the salt solution comprises a zwitterionic salt.

28. The multi-material electrode device of claim 1, wherein the dielectric material comprises potassium iodide.

29. The multi-material electrode device of claim 1, wherein the dielectric material comprises an absorbent fiber material.

30. The multi-material electrode device of claim 1, further comprising an insulating layer separating the first electrode from the second electrode, and the dielectric material covers one or more surfaces of the electrodes not in contact with the insulating layer.

31. The multi-material electrode device of claim 30, wherein the insulating layer comprises polyethylene.

32. The multi-material electrode device of claim 1, wherein the dielectric material forms an external layer enclosing the first electrode and the second electrode.

33. A multi-material electrode array, comprising:
a first multi-material electrode device, comprising:
a first electrode;
a first dielectric material coupled to the first electrode;
a second electrode coupled to the first dielectric material; and
a second multi-material electrode, comprising:
a third electrode;
a second dielectric material coupled to the first electrode; and
a fourth electrode coupled to the first dielectric material; and
wherein the first electrode and the second electrode do not comprise the same material; and
wherein the third electrode and the fourth electrode do not comprise the same material.

34. The multi-material electrode array of claim 33, wherein the first electrode and the third electrode comprise a carbon-based material.

35. The multi-material electrode array of claim 34, wherein the first electrode and the third electrode comprise titanium.

36. The multi-material electrode array of claim 34, wherein the first electrode and the third electrode comprise copper.

37. The multi-material electrode array of claim 34, wherein the second electrode and the fourth electrode comprise aluminum.

38. The multi-material electrode array of claim 34, wherein the second electrode and the fourth electrode comprise a carbon-based material.
